(19) United States
(12) Patent Application Publication
(10) Pub. No.: US 2005/0110259 A1
(43) Pub. Date: May 26, 2005

(54) Hamper securing apparatus and method

(76) Inventors: Jeffrey E. Church, Canastota, NY (US); David C. Dudzinski, North Syracuse, NY (US)

Correspondence Address: Finnegan, Henderson, Farabow,;Garrett & Dunner, L.L.P., 1300 I Street, N.W., Washington, DC, 20005-3315, US

(21) Appl. No.: 10/825,155

(22) Filed: Apr. 16, 2004

Related U.S. Application Data
(60) Provisional application No. 60/463,252, filed on Apr. 16, 2003.

(51) Int. Cl. B60R 1/00

(52) U.S. Cl. 280/762

(57) ABSTRACT

An embodiment consistent with the invention is an apparatus for and method of enabling a securing strap to reliably secure a container. The apparatus restrains the movement of the strap on the container. The apparatus has a hook portion having an opening disposed to engage the upper portion of a container and a loop portion disposed to be below the hook portion. The loop portion comprises an opening for receiving a strap therethrough, and includes a section disposed to prevent downward motion of a strap within the opening.

Priority under 35 U.S.C. § 119 is claimed based on U.S. Provisional Application No. 60/463,252, filed on Apr. 16, 2003, the disclosure of which is expressly incorporated herein by reference.

### BACKGROUND

Technical Field

Embodiments disclosed herein relate to an apparatus and method for reliably securing containers to walls of moving vehicles.

The United States Postal Service (USPS) transports mail in a variety of vehicles. In large vehicles, the mail is transported in large containers. These containers are referred to as “hampers” and are open from the top and are approximately 3.5 feet high, 4 feet long, and 2.6 feet wide at the top. They have a generally rectangular cross section, but taper through approximately the bottom third of their height to a narrower base on which are mounted wheels. Some of these hampers are constructed of molded plastic and have a wall thickness of approximately two inches. Other hampers are constructed of a generally rectangular, open metal frame with a fabric sack suspended from the portion of the frame defining the top opening. The frame also has vertical portions leading to a bottom frame with wheels mounted thereon. The sides of the metal frame generally do not have the taper described above with respect to the hampers constructed of plastic.

The combined weight of the hampers and the mail they contain when fully loaded is substantial. If the loaded hampers are not restrained in some manner the loaded hampers could move about within the cargo bay of the transporting vehicle with the possibility of damaging other hampers or the interior of the cargo compartment of the transporting vehicle. In addition, the moving could damage any mail spilled into the cargo compartment or possibly damage mail within the hampers as they move about within the cargo compartment of the vehicle.

The USPS previously used straps that were approximately 2 inches wide and of various lengths to secure the hampers to the interior walls of the vehicle. Each end of the strap has a clip with which it can be removably attached to the wall, by placing a portion of the clip into a vertical slot in a horizontally mounted rail on the interior walls of the cargo compartment of the vehicle. In one embodiment the clips include a T-shaped portion that is inserted into a horizontal slot the approximate size of the upper portion of the T and then slid vertically downward within a narrow vertically disposed slot. The rails in which the strap clips fit are mounted a few feet above of the floor of the cargo compartment of the vehicle. When the straps are pulled tight around at least a portion of the perimeter of the plastic tapered hamper, the strap may work its way down the tapered portion, creating slack in the strap. The hamper may then start to move and the more motion, the further down the strap slips. The strap may even fall to the floor of the cargo compartment and then the hamper is no longer secured to the wall of the cargo compartment of the vehicle.

There is a need for a simple, inexpensive apparatus and method to prevent a restraining strap from sliding down the sides of a tapered container and reliably securing the container to the interior wall of the cargo compartment of a vehicle.

### SUMMARY

As embodied and broadly described herein, an embodiment consistent with the invention is an apparatus for enabling a securing strap to reliably secure a container. The apparatus has a hook portion having an opening disposed to engage the upper portion of a container and a loop portion disposed to be below the hook portion. The loop portion comprises an opening for receiving a strap therethrough, and includes a section disposed to prevent downward motion of a strap within the opening.

Another embodiment consistent with the invention is a method of securing a container to a wall. The method includes placing a container having four sides with one side abutting the wall, providing a strap detachably affixable to the wall and providing a strap movement-restraining member on the upper edge of the container. The strap movement-restraining member has a hook portion for engaging the edge and a loop portion for receiving the strap. The loop portion has an opening surrounding the strap. The first end of the strap is affixed to the wall, the second end of the strap is passed through the opening in the removable loop, and the second strap end is affixed to the wall to exert a force on the container primarily in a direction toward the wall.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments consistent with the invention and together with the description, serve to explain the principles of the invention. In the drawings,

FIG. 1 perspective view of a tapered container secured at least in part through the use of an embodiment consistent with the invention; and

FIG. 2 is a side view of an embodiment consistent with the invention.

### DESCRIPTION OF EMBODIMENTS

Reference will now be made in detail to the exemplary embodiments consistent with the invention, examples of which are illustrated in the accompanying drawings. Wherever possible, the same reference numbers will be used throughout the drawings to refer to the same or like parts.

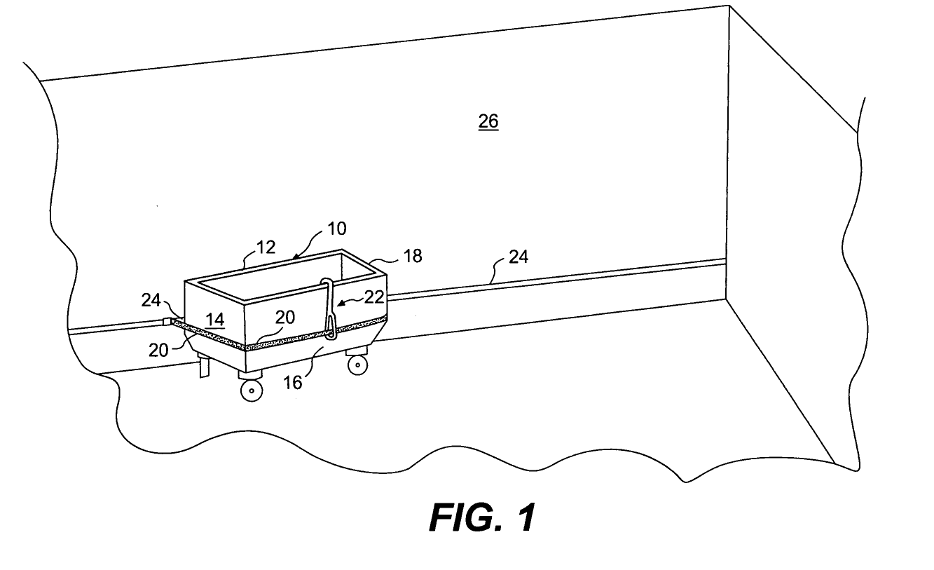

As illustrated in FIG. 1, a container, referred to herein as a hamper 10 has a back wall 12, a first side wall 14, a front wall 16, and a second side wall 18. Each of walls 12, 14, 16, and 18 narrows toward the base forming a taper over the bottom third of the height of hamper 10. The bottom edges of walls 12, 14, 16 and 18 are mounted to a bottom wall (not shown) the perimeter of which is smaller in dimension than the opening formed by the top edges of walls 12, 14, 16, and 18. As here embodied there is included a removable member, shown in FIG. 1 as member 22. The member 22 is detachably engaged on the edge of wall 16 of hamper 10 and is suspended vertically therefrom. Hamper 10 may be secured to the interior of a vehicle having a walled cargo compartment. As here embodied, the cargo compartment has an interior wall 26. The hamper 10 is restrained within the cargo compartment by detachably affixing each end of an elongated, flexible restraining member (here strap 20) to the interior wall 26. As here embodied the interior wall 26 includes a rail 24 (commonly referred to as an “e track”) having attachment means onto which can be detachably affixed the opposite ends of the strap 20. The strap 20 may be elastic with a length less than the combined length of three of the walls of the hamper 10 or it may be non-elastic but having an adjustable length to apply force against the hamper 10 forcing it into contact with the interior wall 26. The member 22 includes an opening 23. Strap 20 is passed through the opening 23 and, assuming the member 22 is disposed vertically, is constrained in the vertical direction. Thus member 22 prevents strap 20 from sliding down the tapered portion of hamper 10. Thus once strap 20 is tight and its ends are clipped into the rail 24, hamper 10 is secured to interior wall 26. When the vehicle moves and thus interior wall 26 moves, strap 20 does not slide down and hamper 10 remains secured to interior wall 26 until the ends of strap 20 are detached from rail 24.

An embodiment consistent with the invention may comprise a rod, shaped to form a hook and loop in the same plane. It could also be shaped to form two hooks. If two hooks are used, a strap does not need to be threaded through the opening, but may be slipped between the opposing portions of the hook, requiring less time and fewer motions to place the strap in the securing portion of the apparatus. However, a loop is preferred for the additional safety that it offers, preventing the otherwise unattached end of the hook that receives the restraining strap from catching or impaling objects.

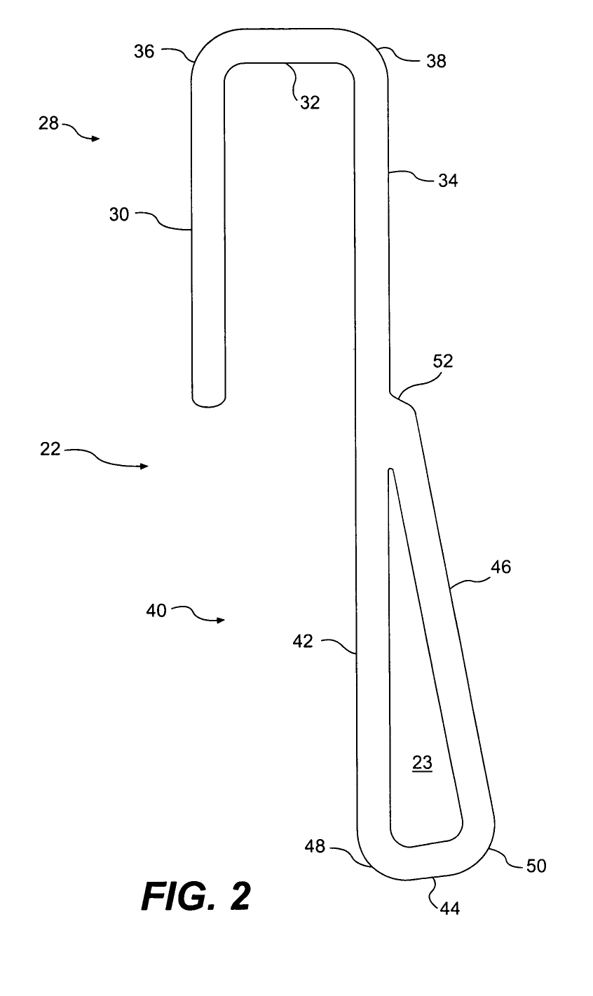

FIG. 2 illustrates one embodiment of a detachably removable strap-retaining member consistent with the invention. As here embodied, removable member 22 comprises a hook portion 28 comprising three straight sections, a catch section 30, a top-engaging section 32, and a shank 34. As here embodied, sections 30, 32, and 34 are connected at generally right angles 36 and 38. Alternatively hook portion 28 may comprise curved sections. Either way, hook portion 28 is generally an inverted U-shape. In either of such embodiments the distance between opposing sides of the hook (here catch section 30 and shank 34) should be approximately the thickness of the wall of the container at the edge that is to receive the member 22 (as here embodied, the upper edge of side 16 of hamper 10). It could be slightly less and therefore have some clamping action, or it could be slightly more and slide freely on the upper edge of the container wall.

Returning to FIG. 2, a part of shank 34 may also form a straight section 42 of a loop portion 40. Loop portion 40 may comprise three straight sections 42, 44, and 46, connected by three acute angles 48, 50, and 52 and forming a triangular opening 23, with the longest of the three sections (46) being joined by welding to the shank 34 of the hook portion at an end of straight section 42 of the loop portion 40. As here embodied, member 22 is made of round metal rod stock, with one end welded back on itself to form loop portion 40.

An apparatus consistent with the invention may be mounted on the exterior surface of one of the walls of the hamper by means of a hook portion coupled to it that hangs from the top edge of one of the walls and preferably clamps to the interior and exterior surfaces of that same wall. The dimensions of the hook portion of the apparatus influences the ability of the hook to resist motion once installed on the hamper. The longer the portion of the hook that rests in the interior of the hamper (the catch section), the more it can resist being dislodged when the cargo of the vehicle experiences vertical motion, as, for example, the result of hitting bumps in the road. The higher the clamping force that the hook portion of the apparatus exerts on the wall of the container the greater resistance it can offer to vertical (or otherwise) forces experienced while the vehicle is in motion or at anytime, including installation.

However, the shape of the hook portion of the apparatus also influences the ease of installation. In its preferred shape, the apparatus is able to be installed and removed by the vehicle driver without the aid of tools, simply by aligning the opening of the hook portion of the apparatus over the edge of the hamper wall where it is desired to be installed and applying downward hand pressure to slightly spread the opposing sides of the hook to fit the dimensions of the thickness of the container wall.

While preferably used with open top containers, it can be envisioned to be mounted on closed top containers. In order to do so, the hook portion of the apparatus which preferably clamps onto what ever it is mounted will have to change in dimension to capture two opposing sides. Should the container be round, then the hook portion may comprise five straight sections: one shank connected to two top engaging sections, which form an acute angle between themselves, and two catch sections, each connected to its corresponding top engaging section. Each top engaging section would be approximately the length of whatever chord length it is designed to cross. Alternatively, the top engaging sections could have a hub and spoke construction, comprising three coupled horizontal sections: one connected to the shank, and the other two connected to catch sections. In each of these embodiments for cylindrical containers, the apparatus could foreseeably rotate, but not dislodge due to the expected motion of the vehicle.

Even with the open top hampers, a hook portion could encompass the width of the hampers and thus clamp on the outside of back wall, 12, and the outside of front wall, 14. However, it would require more mass and would be thus heavier to install and require more room for storage when not in use.

As the shape of the hook portion of the apparatus may be designed to fit the particular container to which it preferably clamps when installed, the dimensions of the loop and the location of the loop, once mounted on the container are also with in the scope of this invention. Thus the loop may be of any shape, should restrain movement of a strap placed therein in the direction in which it is desired that the securing strap not be able to move. In the preferred embodiment, the member is disposed to be vertically oriented on the container and the loop has a lower section which prevents the strap from sliding down the container wall.

Other embodiments consistent with the invention will be apparent to those skilled in the art from consideration of the specification and practice of the invention disclosed herein. It is intended that the specification and examples be considered as exemplary only, with a true scope and spirit of the invention being indicated by the following claims.

1. An apparatus for enabling a securing strap to reliably secure a container comprising:
a hook portion having an opening disposed to engage the upper portion of a container;
a loop portion disposed to be below said hook portion, said loop portion comprising an opening for receiving a strap therethrough, said loop portion including a section disposed to prevent downward motion of a strap within said opening.

2. The apparatus of claim 1, wherein the hook portion is an inverted U-shape where the horizontal portion of the U-shaped hook section has a length approximately the thickness of the upper portion of the container the hook portion is to engage.

3. The apparatus of claim 1, wherein the hook portion is an inverted U-shape where the horizontal portion of the U-shaped hook section has a length less than the thickness of the upper portion of the container the hook portion is to engage.

4. The apparatus of claim 1, wherein the loop portion includes an elongated opening disposed to receive said strap.

5. The apparatus of claim 1, wherein the loop portion is generally triangular.

6. The apparatus of claim 1, wherein the length of a catch section of the hook is approximately three times the length of a top engaging section.

7. The apparatus of claim 1, wherein the hook portion and loop portion are integral portions of a one-piece unit.

8. The apparatus of claim 1, wherein the loop portion is made by welding an end of round rod back onto the shank of the apparatus.

9. A system for restraining an open-top container within a walled cargo compartment, said system comprising:
an elongated strap having a length that is changeable to be approximately the length of three sides of said container, at least one end of said strap having a mechanical attachment detachably affixing at least one end of said strap to an interior wall of said walled cargo container;
a strap movement-restraining member having a hook portion disposed to engage the upper portion of a container, said hook portion being generally an inverted U-shape with the horizontal portion of the U-shaped section having a length approximately the thickness of the upper portion of the container, said restraining member further having a loop portion disposed to be below said hook portion, said loop portion comprising an opening for receiving said strap therethrough, said loop portion completely surrounding said strap within said opening.

10. A method of securing a container to a wall, comprising:
placing a container having four sides with one side abutting the wall;
providing a strap detachably affixable to the wall;
providing a strap movement-restraining member on the upper edge of the container, the strap movement-restraining member having a hook portion for engaging said edge and a loop portion for receiving said strap, said loop portion having an opening surrounding said strap;
affixing a first end of said strap to the wall;
passing a second end of said strap through the opening in the removable loop;
affixing the second strap end to the wall to exert a force on said container primarily in a direction toward said wall.

11. The method of claim 10 including the step of changing the length of said strap before securing the second strap end to the wall.

12. The method of claim 10 including the step of changing the length of said strap after securing the second strap end to the wall.

13. The method of claim 11 wherein said strap is non-elastic and has an adjustable length.

14. The method of claim 11 wherein said strap is elastic such that said strap has an adjustable length.

15. The method of claim 10, wherein the strap movement-restraining member is made of round rod stock with one end welded back on itself to form the opening of the loop portion.
